(19) United States
(12) Patent Application Publication
(10) Pub. No.: US 2017/0309924 A1
(43) Pub. Date: Oct. 26, 2017

(54) SOLID POLYMER ELECTROLYTE FUEL CELL WITH IMPROVED VOLTAGE REVERSAL TOLERANCE

(71) Applicants: Daimler AG, Stuttgart (DE); Ford Motor Company, Dearborn, MI (US)

(72) Inventors: Sumit Kundu, Burnaby (CA); Scott McDermid, Vancouver (CA); Amy Shun-Wen Yang, Port Coquitlam (CA); Liviu Catoiu, New Westminster (CA); Darija Susac, Richmond (CA)

(21) Appl. No.: 15/649,150

(22) Filed: Jul. 13, 2017

Related U.S. Application Data
(63) Continuation of application No. 13/550,685, filed on Jul. 17, 2012.
(60) Provisional application No. 61/508,790, filed on Jul. 18, 2011.

(51) Int. Cl. H01M 4/92; H01M 8/1007; H01M 4/88

(52) U.S. Cl. CPC H01M 4/926; H01M 4/925; H01M 4/923; H01M 8/1007; H01M 4/8828; H01M 4/92

(57) ABSTRACT

In solid polymer electrolyte fuel cells, an oxygen evolution reaction (OER) catalyst may be incorporated at the anode along with the primary hydrogen oxidation catalyst for purposes of tolerance to voltage reversal. Incorporating this OER catalyst in a layer at the interface between the anode's primary hydrogen oxidation anode catalyst and its gas diffusion layer can provide greatly improved tolerance to voltage reversal for a given amount of OER catalyst. Further, this improvement can be gained without sacrificing cell performance.

### FIELD OF THE INVENTION

The present invention pertains to solid polymer electrolyte fuel cells, and particularly to anode components for such cells for obtaining improved tolerance to voltage reversal tolerance.

### BACKGROUND OF THE INVENTION

Solid polymer electrolyte fuel cells electrochemically convert reactants, namely fuel (such as hydrogen) and oxidant (such as oxygen or air), to generate electric power. These cells generally employ a proton conducting polymer membrane electrolyte between two electrodes, namely a cathode and an anode. A structure comprising a proton conducting polymer membrane sandwiched between two electrodes is known as a membrane electrode assembly (MEA). In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1 V, a plurality of cells is usually stacked together in series for commercial applications. Fuel cell stacks can be further connected in arrays of interconnected stacks in series and/or parallel for use in automotive applications and the like.

If for some reason a cell (or cells) in a series stack is not capable of delivering the same current being delivered by the other cells in the stack, that cell or cells may undergo voltage reversal. Depending on the severity and duration of the voltage reversal, the cell may be irreversibly damaged and there may be an associated loss in cell and stack performance. Thus, it can be very important in practical applications for the cells in large series stacks to have a high tolerance to voltage reversal.

U.S. Pat. No. 6,936,370 discusses some of the various circumstances which can result in a fuel cell being driven into voltage reversal. One means for making such fuel cells more tolerant to cell reversal is to promote water electrolysis over anode component oxidation at the anode. This can be accomplished by incorporating a catalyst composition at the anode to promote the water electrolysis reaction, in addition to the typical anode electrocatalyst for promoting fuel oxidation. Such catalysts are also known as oxygen evolution reaction (OER) catalysts.

Certain preferred additional catalyst compositions for reversal tolerance at the anode have been suggested in the art (e.g. a single-phase solid solution of a metal oxide containing Ru, such as RuIrO₂). Further, it has been suggested to incorporate such catalysts in admixtures or alternatively in separate layers at the anode. However, in general, anodes comprising admixtures are easier and cheaper to manufacture than those with separate layers. Thus, absent any significant benefit to the latter, the former would be preferred.

These and other aspects related to anode structures for achieving reversal tolerance are discussed in various patent documents, including for instance U.S. Pat. No. 7,608,358, WO2008/024465, and US2007037042.

While advances have been made with regards to obtaining both a desirable voltage reversal tolerance in fuel cells, this generally involves an increase in cost and sometimes a modest trade-off in cell performance. Thus, there still remains a need for means for obtaining better reversal tolerance while minimizing impact on cost and performance.

### SUMMARY OF THE INVENTION

In fuel cells with anodes comprising both a primary catalyst composition for the primary hydrogen oxidation in the fuel cell, and a secondary catalyst composition for reversal tolerance via an oxygen evolution reaction, it has been found that locating the secondary catalyst composition in a discrete layer between the primary catalyst composition and an anode gas diffusion layer provides an unexpected, marked improvement in reversal tolerance for a given amount of added secondary catalyst composition. Consequently, much less secondary catalyst composition is required to obtain a desired reversal tolerance than would be if the two compositions were admixed in a single layer. Further, a durability trade-off has generally been noticed with increasing amounts of secondary catalyst composition, particularly with regards to performance after repeated startup and shutdown cycling. Thus, locating the secondary catalyst composition according to the invention can also provide for desirable reversal tolerance without sacrificing cell durability.

In particular, a solid polymer electrolyte fuel cell of the invention comprises a cathode, a solid polymer electrolyte, an anode, a cathode gas diffusion layer, and an anode gas diffusion layer. The anode comprises a primary catalyst composition for hydrogen oxidation and a secondary catalyst composition for oxygen evolution reaction. And unlike typical fuel cells in the prior art, the primary catalyst composition is incorporated as a layer located adjacent the solid polymer electrolyte, the secondary catalyst composition is incorporated as a layer located between the primary catalyst composition and the anode gas diffusion layer, and the loading of the secondary catalyst composition is in the range from 1 to 90 micrograms/cm². In other embodiments, the loading of the secondary catalyst composition can desirably be less than or about 40 micrograms/cm². Amounts as low as or less than 20 micrograms/cm² of secondary catalyst composition can provide a marked improvement in reversal tolerance without significant effect on cell performance or durability.

The anode in such fuel cells preferably may consist essentially of the primary catalyst composition layer and the secondary catalyst composition layer. That is, the anode may be absent an intermediate or other layer. However, the anode gas diffusion layer may comprise an additional layer, such as a microporous layer adjacent the secondary catalyst composition layer.

The primary catalyst composition in the anode generally appears as a layer located adjacent the solid polymer electrolyte membrane in the fuel cell. The primary catalyst composition can be any of those conventionally used as a primary anode catalyst including dispersed anodes, NSTF (nano-structured thin film) anodes, Pt on tungsten oxide, etc. In particular, the primary catalyst composition can be Pt (or alloys thereof) on different supports such as carbon, tungsten, perylene, and metal oxides. Other precious metals such as palladium (or alloys thereof) may also be used.

The secondary catalyst composition in the anode appears as a layer located between the primary catalyst composition and an anode gas diffusion layer (GDL) and may be applied using various conventional processes (coating, sputtering, etc.). The GDL may additionally comprise a microporous layer and thus the secondary catalyst composition may be located between the primary catalyst composition layer and the microporous layer of the anode GDL. The secondary catalyst composition may particularly be RuIrO₂, but also other oxygen evolution reaction compositions such as other oxides with varied ratios of Ru to Ir, RuO₂, IrO₂, Ru, Ir, and solid solutions may be considered. Indeed, any compositions particularly suited for voltage reversal or oxygen evolution reaction purposes, such as those cited in U.S. Pat. No. 6,936,370 may be expected to be suitable for use.

Further, the secondary catalyst composition layer may comprise less than 20 micrograms/cm² of carbon additive. And, the secondary catalyst composition layer may additionally comprise perfluorosulfonic acid type polymer additive in which the ratio of polymer additive to secondary catalyst composition is less than or about 0.1.

Such fuel cells can be prepared by incorporating the secondary catalyst composition layer in cells made in an otherwise conventional manner on assembly. That is, each layer can be incorporated on assembly of the fuel cell using a variety of conventional techniques. In one such embodiment, the secondary catalyst composition layer can be incorporated by preparing a solid-liquid dispersion comprising the secondary catalyst composition and a carrier liquid, applying a coating of the dispersion to the primary catalyst composition layer or, in particular, the anode gas diffusion layer, and removing the carrier liquid.

The steps of incorporating the primary catalyst composition as a layer located adjacent the solid polymer electrolyte, incorporating the secondary catalyst composition as a layer located between the primary catalyst composition and the anode gas diffusion layer wherein the secondary catalyst composition layer is characterized by a loading of the secondary catalyst composition, and reducing the loading of the secondary catalyst composition to a value in the range from 1 to 90 micrograms/cm² can result in improved durability while maintaining reversal tolerance of such solid polymer electrolyte fuel cells. Substantial improvements in reversal tolerance can be achieved in this way versus using admixed catalyst methods.

### BRIEF DESCRIPTION OF THE FIGURES OF THE DRAWINGS

FIG. 1 shows a schematic exploded view of the various components making up a unit cell for an exemplary solid polymer electrolyte fuel cell of the invention.

FIG. 2 shows plots of average cell voltage versus cycle number for a series of comparative fuel cell stacks undergoing accelerated startup and shut down cycle testing.

FIG. 3 compares plots of average cell voltage versus time during cell reversal for a cell of the invention and two different comparative cells.

### DETAILED DESCRIPTION OF THE PREFERRED EMBODIMENTS

The present invention allows oxygen evolution reaction catalysts to be employed at fuel cell anodes at low loadings while obtaining reversal tolerance equivalent to or better than that which was previously obtained at much higher loadings. In addition, the adverse effect of much higher loadings on cell performance (particularly durability upon repeated startup and shutdown cycling) is mitigated.

This improvement is obtained by locating a secondary catalyst composition comprising the oxygen evolution catalyst in a discrete layer between the primary anode catalyst composition and the anode GDL instead of employing conventional methods of introducing the secondary catalyst composition, and especially instead of admixing the primary and secondary catalyst compositions together into a single layer as is presently conveniently done in the art.

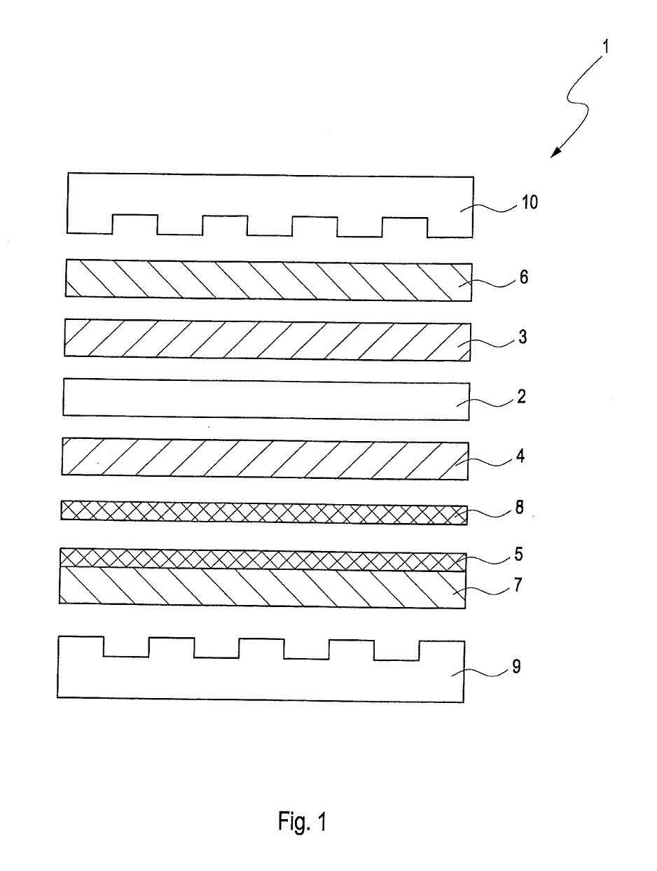

FIG. 1 shows an exploded schematic view of the various components making up a unit cell for an exemplary solid polymer electrolyte fuel cell of the invention. Unit cell 1 comprises a solid polymer membrane electrolyte 2, cathode 3, and anode 4 comprising the primary anode composition for the hydrogen oxidation reaction taking place in the fuel cell. Adjacent the two cathode and anode electrodes are cathode GDL 6 and anode GDL 7 respectively. As shown in FIG. 1, anode GDL 7 comprises microporous layer 5 applied to the side nearest electrolyte 2. Adjacent the two GDLs are cathode flow field plate 10 and anode flow field plate 9.

In accordance with the invention, an essentially discrete layer 8 comprising the secondary catalyst composition (and hence the oxygen evolution reaction catalyst) is located between primary anode 4 and microporous layer 5 of anode GDL 7. Note that those skilled in the art appreciate that some modest intermixing of primary and secondary catalyst composition at their interface may be expected in practice. Thus, layer 8 may be considered essentially discrete, because a modest intermixing at the interface is expected

Layer 8 may be provided in a number of conventional ways. A preferred method starts with a solid-liquid dispersion of suitable ingredients and, using a suitable coating technique, applying a coating of the dispersion to a selected anode component. For instance, layer 8 may be applied to a catalyst coated membrane (CCM) in which cathode 3 and primary anode 4 have already been applied to electrolyte 2 to create a unitary CCM assembly. Alternatively, layer 8 may be applied to microporous layer 5 of anode GDL 7. After application, the coated component is dried and optionally subjected to other post-treatment (e.g. sintering). Further still, coating techniques can be used to prepare discrete layers (e.g. a coating may be applied to a release film, dried, and then applied under elevated temperature and pressure so as to bond to a selected anode component).

A dispersion for applying coatings in this manner will typically comprise an amount of the desired oxygen evolution reaction catalyst particles, one or more liquids in which the particles are dispersed, and optionally other ingredients such as binders (e.g. ionomer, PTFE) and/or materials for engineering porosity or other desired characteristics in layer 8. Water is a preferred dispersing liquid but alcohols and other liquids may be used to adjust viscosity, to dissolve binders, and so forth.

Conventional coating techniques, such as Mayer rod coating, knife coating, decal transfer, or other methods known to those skilled in the art, may be employed to apply dispersion onto or into a selected anode component.

Primary anode 4 may be any conventionally used fuel cell anode catalyst including dispersed anodes, NSTF anodes, Pt on tungsten oxide, etc. In particular, the primary catalyst composition can be Pt (or alloys thereof) on different supports such as carbon, tungsten, perylene, and metal oxides. Other precious metals such as palladium may also be used.

Layer 8 comprises a suitable oxygen evolution reaction catalyst for reversal tolerance purposes. A preferred such catalyst is RuIrO₂, but also other oxygen evolution reaction compositions such as other oxides with varied ratios of Ru to Ir, RuO₂, IrO₂, Ru, Ir, and other solid solutions thereof are expected to be particularly suitable for use.

As illustrated in the Examples to follow, amounts as low as 20 micrograms/cm² of such catalysts can provide a marked improvement in reversal tolerance without a significant adverse effect on cell performance. In general though, it is expected that the benefits of the invention may still be obtained with higher amounts, such as 40, 80, or up to even 90 micrograms/cm² of such catalysts.

Incorporating the oxygen evolution reaction catalyst essentially in discrete layer 8 provides unexpectedly superior reversal tolerance for a given amount of catalyst, without affecting cell performance. Without being bound by theory, it is believed that the bulk of the oxygen evolution reaction taking place during cell reversal occurs near the interface of primary anode 4 and anode GDL 7. Thus, placing layer 8 at this interface may increase the utilization of the oxygen evolution reaction catalyst therein and thus lead to longer (i.e. greater) tolerance to cell reversal conditions. Further, it is known that some dissolution of such catalysts can occur during use and this can affect cell performance. For instance, Ru coming from a Ru based secondary anode catalyst composition may migrate to the cathode and cause performance degradation of the fuel cell. This risk is reduced by reducing the amount of secondary catalyst composition and by locating it further away from the cathode.

The following Examples have been included to illustrate certain aspects of the invention but should not be construed as limiting in any way. As an example, those skilled in the art will appreciate that the invention is not limited just to fuel cells operating on pure hydrogen fuel but also to fuel cells operating on any hydrogen containing fuel, such as reformate.

### EXAMPLES

### Comparative Example 1

A series of fuel cell stacks were made with differing amounts of oxygen evolution reaction catalyst admixed with a conventional primary anode catalyst to create a single layer admixed anode. These cells were then subjected to an accelerated startup and shutdown cycle durability test.

The fuel cells in this series all comprised a catalyst coated membrane in which the electrolyte was a perfluorosulfonic acid type polymer membrane, the cathode catalyst was carbon supported platinum at a loading of 400 μg of Pt per cm², and the anode was an admixture of carbon supported platinum and RuIrO₂. The loading of carbon supported Pt was 50 μg of Pt per cm². Various loadings of RuIrO₂ were employed including 0, 40, and 240 μg/cm² of RuIrO₂. All catalyst layers also contained conventional amounts Nafion ionomer for purposes of ionic conduction, pore structure, etc. The cells also comprised of conventional gas diffusion layer materials on the anode and cathode consisting of treated carbon fibre paper and a microporous layer applied by the manufacturer.

The cells were subjected to startup/shutdown cycles which involves repeatedly switching the gas supplied to the anode between hydrogen and air to simulate the effects of air ingress which takes place on startups and shutdowns. The cycling comprised an idle phase with the cells operating at a current of 0.05 A/cm² for 30 seconds, followed by an anode air purge for 60 seconds where the supplied anode gas was switched from hydrogen to air. The stack was allowed to soak in an air-air state for 600 seconds followed by the re-introduction of hydrogen to the anode. Every cycle included 0.69 A/cm² steady state operation lasting 300 seconds and every tenth cycle included steady state operation at 1.03 A/cm² for 30 minutes.

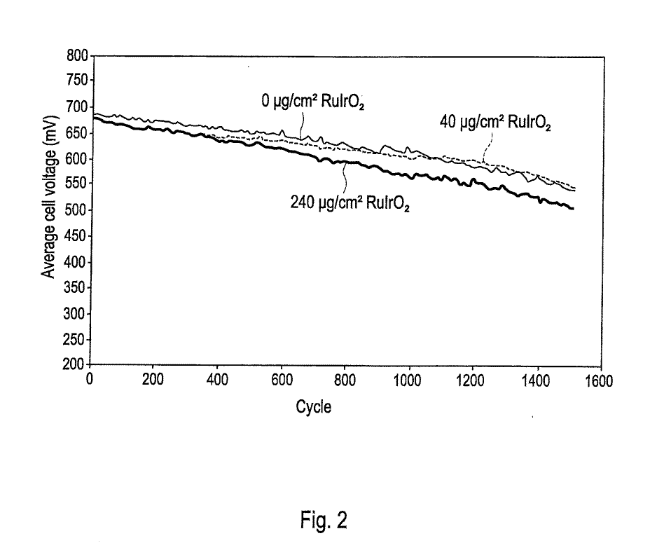

FIG. 2 compares plots of average cell voltage at 1.03 A/cm² versus number of startup/shutdown cycles for all the cells tested here. (In FIG. 2, the cells have been denoted as 0, 40 and 240 μg/cm² RuIrO₂ in accordance with their content of RuIrO₂ catalyst.) All the cells showed a slow degradation in voltage with cycle number. However, the degradation was worse in cells comprising greater loadings of the oxygen evolution reaction catalyst RuIrO₂. The cell with the lower loading of 40 μg/cm² by weight of RuIrO₂ was not too different from that with no RuIrO₂ at all. Such a low loading therefore does not adversely affect durability too greatly. However increasing the loading to 240 μg/cm² does have a significant adverse effect.

This example shows how greater amounts of the secondary catalyst composition comprising RuIrO₂ in the cell anodes adversely affects cell durability when subjected to numerous startup and shutdown cycles. This example also illustrates the trade-off when applying these materials to achieve greater and greater reversal tolerance.

### Comparative Example 2

A series of three comparative fuel cells were made with the same amounts of oxygen evolution reaction catalyst used in the anode but which were incorporated in different layer structures. A cell like those in Comparative Example 1 was prepared in which the anode was an admixture of carbon supported platinum and RuIrO₂ except that the loading of carbon supported Pt was 100 μg/cm² of Pt and the loading of RuIrO₂ was 40 μg/cm² of RuIrO₂.

In addition, two other cells were made in a like manner, and had the same total loading of carbon supported platinum and RuIrO₂ catalyst present. Here however, the anodes comprised three different layers. The three layer structure in both these cells comprised the following layers stacked in series: a layer comprising the carbon supported platinum catalyst, ionomer and conductive carbon additive; an intermediate layer consisting only of ionomer and conductive carbon additive; and a layer comprising the RuIrO₂ catalyst, ionomer and conductive carbon additive. In one fuel cell, the carbon supported platinum layer was located adjacent the membrane electrolyte. (This cell therefore had a somewhat similar construction to that of the invention in that the oxygen evolution catalyst was located in a discrete layer between the primary anode catalyst composition and the anode GDL. However, unlike the Inventive Example below, an additional third layer was present here.) In the other cell, the layered anode was reversed and the carbon supported platinum layer was located adjacent the anode gas diffusion layer.

The cells were then subjected to an extended voltage reversal test which consisted of drawing a load of 0.2 A/cm² while running the fuel cell with air on the cathode and nitrogen on the anode (to simulate a fuel starvation event). The end of the test was determined by when the average cell voltage dropped below −2.5 V. The time required to reach −2.5 V is denoted as the extended reversal tolerance time.

The fuel cell comprising the admixture of carbon supported platinum and RuIrO₂ catalyst had an extended reversal tolerance time of about 79 minutes. The fuel cell comprising the 3 layer anode with the carbon supported platinum adjacent the membrane had a significantly shorter extended reversal tolerance time of only about 43 minutes. The fuel cell comprising the 3 layer anode with the carbon supported platinum adjacent the anode GDL also had a significantly shorter extended reversal tolerance time of only about 42 minutes.

This example demonstrates that the benefits of the invention may not be obtained merely by locating a layer comprising oxygen evolution reaction catalyst adjacent the anode GDL. For instance, incorporating the additional intermediate resulted in inferior reversal tolerance to that of a mere admixture.

### Illustrative Example

A fuel cell was made with similar cathode, membrane, and GDL components as Comparative Example 1 except that the anode comprised a platinum catalyst onto which an oxygen evolution reaction (OER) catalyst was sputtered. The cathode platinum loading was 250 μg/cm² and the anode platinum loading was 50 μg/cm² with an OER catalyst loading of 10 μg/cm².

The cell was subjected to an extended voltage reversal test as described above. The cell demonstrated good extended reversal tolerance time, exceeding 20 h. The cell was then disassembled for post-mortem analysis. Scrapings of the anode catalyst were obtained and imaged using transmission electron microscopy to visualize the anode catalyst and the OER catalyst post reversal. It was noticed that the bulk of the OER catalyst migrated during the reversal test from the surface of the anode NSTF catalyst, where it was originally sputtered, to the anode microporous layer. Subsequent testing, where reversal testing was stopped at different times showed that significant migration occurred within the first hour of reversal testing. Despite the degree of OER catalyst migration, the MEA had reasonably good reversal tolerance times.

This example illustrates that despite the oxygen evolution reaction catalyst moving to the interface between the primary anode catalyst and the anode GDL, the relatively high reversal tolerance exhibited by the test fuel cell is maintained and thus the catalyst is still active at that interface.

### Inventive Example 1

A series of cells was again made as in Comparative Example 1 above comprising RuIrO₂ in the anodes. Two comparative cells were made in which the RuIrO₂ was provided as an admixture in the primary anode layer as above in amounts of either 20 or 240 μg/cm² by weight of RuIrO₂. These cells were denoted Comparative 20 μg/cm² RuIrO₂ and Comparative 240 μg/cm² RuIrO₂ respectively. Note that the Comparative 20 μg/cm² RuIrO₂ cell had a cathode Pt loading of 250 μg/cm² and anode loading of 50 μg/cm², while the Comparative 240 μg/cm² RuIrO₂ cell had a cathode Pt loading of 400 μg/cm² and anode loading of 100 μg/cm². A third Comparative cell with no RuIrO₂ was also prepared. Finally, a cell of the invention was prepared with no RuIrO2 in the primary anode layer and a primary anode Pt loading of 50 μg/cm². Instead, a secondary anode catalyst composition comprising 20 μg/cm² RuIrO₂ was provided at the interface between the primary anode layer and the microporous layer of the anode GDL as shown schematically in FIG. 1. This cell was denoted Inventive 20 μg/cm² RuIrO₂ and had a cathode loading of 250 μg/cm². Each cell used a PFSA based membrane and anode and cathode GDL comprising carbon fibre paper with a microporous layer applied by the manufacturer.

To prepare this inventive cell, first an ink consisting of about 1 g of RuIrO₂, 0.6 g of Nation dispersion (10% solids), 2 g of methyl ethyl ketone, and 19 g of de-ionized water was prepared. The ink dispersion was mixed manually with a spatula and then sonicated (using a sonication probe at 50 W power) for 5 min. Acetone was added into the ink to further dilute to <5% solids. Then, an air spray gun was used to spray the ink onto the anode GDL to achieve a loading of about g/cm² RuIrO₂ on the GDL.

Polarization tests (in which voltage as a function of current density is determined) were performed on each cell after fabrication. There was no significant difference in performance between cells.

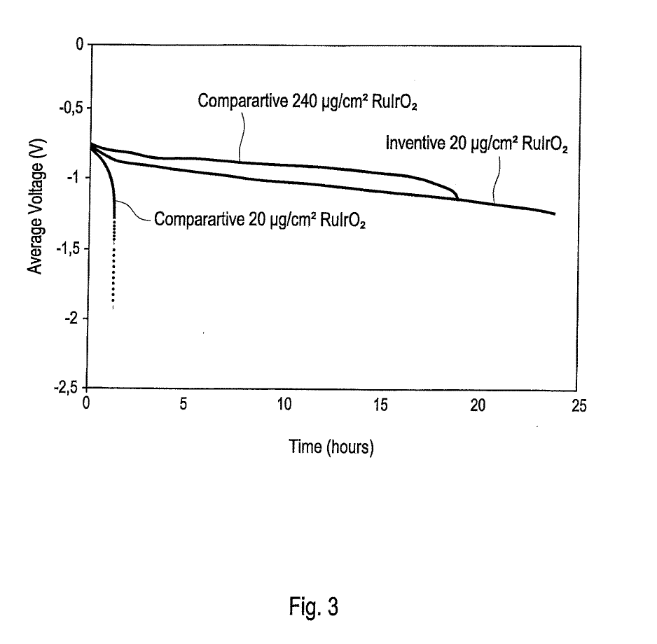

An extended reversal test was then performed on several of the cells in the manner described above. FIG. 3 compares plots of the cell voltage versus time during these cell reversal tests. The Comparative 20 μg/cm² RuIrO₂ cell comprising a conventional admixed single layer anode with a low loading of 20 μg/cm² RuIrO₂ had a reversal tolerance time of only about 71 minutes. The Comparative 240 μg/cm² RuIrO₂ cell with a much greater loading of 240 μg/cm² RuIrO₂ in a conventional admixed layer had a much greater reversal tolerance time and was not tested to test criteria completion. However, the first signs of failure (increased curvature of the plot trend) were apparent at 18 hours into the test. The Comparative 240 μg/cm² RuIrO₂ cell confirms how increasing the OER loading may improve reversal tolerance. However as demonstrated in Comparative Example 1 above, there is a penalty with such higher loadings in, for instance startup and shut down cycle testing. The Inventive 20 μg/cm² RuIrO₂ cell with the same low loading of RuIrO₂, but located as a second discrete layer in accordance with the invention, showed a much greater reversal tolerance time that exceeded (being over 24 hours) that of the highly loaded Comparative 240 μg/cm² RuIrO₂ cell. (Note: While the cathode loadings in these test cells were somewhat different, the effects being tested here related to the anode and it is not believed that differences in cathode loading play a significant role in reversal test results.) The higher anode loading in the Comparative 240 μg/cm² RuIrO₂ cell is expected to improve durability and thus is a conservative comparison to the Inventive example.

Startup/shutdown durability testing (in the manner described in Comparative Example 1 above) was also conducted on the Inventive 20 μg/cm² RuIrO₂ cell and the Comparative cell with no RuIrO₂ catalyst. This testing showed that the Inventive 20 μg/cm² RuIrO₂ cell had a degradation rate of 371 μV/cycle compared to a degradation rate of 362 μV/cycle for the latter Comparative cell. This difference is considered to be within test error and therefore not significant.

This example shows that incorporating oxygen evolution catalyst at the anode in accordance with the invention can provide greatly improved reversal tolerance with very low loading of the catalyst. Further, since such a low loading in conventional cells is not too detrimental to cell performance, it is expected that this improved reversal tolerance is gained without significant adverse effect on cell performance or durability in startup shutdown testing.

### Inventive Example 2

A series of cells was made as in Inventive Example 1 but with varied loadings of RuIrO₂ in the secondary catalyst composition layer applied to the anode GDL. Cells in this series included either 10, 20, 40, or 80 μg/cm² of RuIrO₂ in the applied layer.

Polarization tests were then performed as in the preceding on each cell after fabrication. There was no significant difference in polarization performance between cells. Thus, varying the secondary catalyst composition loading over these amounts seemed to have no impact on polarization performance.

Extended reversal tests were also performed on the cells in a similar but not identical manner to the preceding. Certain parameters differed, and particularly the relative humidities of the reactant gases employed, from those employed above. As a consequence, the absolute values for results obtained for a similar cell in the present Example differ from, and cannot properly be compared to, those in the previous example. However, the relative values within the present and subsequent Examples can meaningfully be compared. (In particular, it is believed that the relative humidity difference resulted in a significant lowering in reversal times generally.)

Table 1 compares the reversal tolerance times determined for each of these cells. As is evident from these results, reversal tolerance time increased with increased loading. The trend is not linear and indicates that, as loading is increased, the reversal tolerance time per microgram of secondary catalyst composition increases. This may be attributed to lower overpotentials experienced during a reversal event when higher loadings are present.

TABLE 1
Extended reversal time versus secondary catalyst composition loading

| RuIrO₂ loading | Extended reversal time |
|---|---|
| (μg/cm²) | (minutes) |
| 10 | 241 |
| 20 | 271 |
| 40 | 408 |
| 80 | 1065 |

### Inventive Example 3

Another series of cells was made as in Inventive Example 1 but with varied amounts of carbon black additive added to the RuIrO₂ based ink and thus also to the secondary catalyst composition layer applied to the anode GDL. Cells in this series included either 0, 10, 20 or 40 μg/cm² of carbon additive with a constant RuIrO₂ content as in Inventive Example 1 of 20 μg/cm².

Polarization and extended reversal tests were then performed as in the preceding on each cell after fabrication. Again, there was no significant difference in polarization performance between cells. Thus, the addition of carbon additive in these amounts seemed to have no impact on polarization performance.

Table 2 compares reversal tolerance times for each of these cells. Including 10 μg/cm² of carbon additive appeared to increase the reversal tolerance time by 7% compared to that of a cell with no carbon additive (but note that this is believed to be just within test error). However, increased amounts of carbon additive in the secondary catalyst composition layer (e.g. 20 μg/cm² and above) seemed to significantly decrease the reversal tolerance time. Thus, it appears preferable for the secondary catalyst composition layer to contain less than 20 μg/cm² carbon additive. It is speculated that the addition of carbon additive, with the corresponding decrease in the concentration of the secondary catalyst composition at the interface with the anode GDL, results in lower utilization during the reversal reaction.

TABLE 2
Extended reversal time versus amount of carbon additive

| Amount of carbon in | Extended reversal time |
|---|---|
| RuIrO₂ layer (μg/cm²) | (minutes) |
| 0 | 271 |
| 10 | 292 |
| 20 | 143 |
| 40 | <7 |

### Inventive Example 4

Another new series of cells was made as in Inventive Example 1 but this time with varied amounts of Nafion ionomer in the RuIrO₂ based ink and thus also in the secondary catalyst composition layer applied to the anode GDL. The loading of RuIrO₂ in the secondary catalyst composition layer for cells in this series was constant at 20 μg/cm². Cells in this series had varied ionomer to secondary catalyst composition weight ratios of 0.06, 0.12 and 0.18.

Polarization and extended reversal tests were then performed as in the preceding on each cell after fabrication. Again, there was no significant difference in polarization performance between cells. Thus, the variation in amount of ionomer seemed to have no impact on polarization performance. Table 3 compares reversal tolerance times for each of these cells. As Table 3 illustrates, reversal tolerance time decreased as the ionomer/RuIrO₂ decreased from 0.06 to either 0.12 and 0.18. Further trials with ionomer/RuIrO₂ ratios lower than 0.06 were attempted. However ink stability became an issue at such values.

TABLE 3
Extended reversal time versus ratio of ionomer/secondary
catalyst composition

| Ionomer/RuIrO₂ ratio | Extended reversal time |
|---|---|
| (by weight) | (minutes) |
| 0.06 | 383 |
| 0.12 | 235 |
| 0.18 | 268 |

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. A solid polymer electrolyte fuel cell comprising a cathode, a solid polymer electrolyte, an anode, a cathode gas diffusion layer, and an anode gas diffusion layer, the anode comprising a primary catalyst composition for hydrogen oxidation and a secondary catalyst composition for oxygen evolution reaction, wherein: the primary catalyst composition is incorporated as a layer located adjacent the solid polymer electrolyte; the secondary catalyst composition is incorporated as a layer located between the primary catalyst composition and the anode gas diffusion layer; and the loading of the secondary catalyst composition is in the range from 1 to 90 micrograms/cm².

2. The fuel cell of claim 1 wherein the loading of the secondary catalyst composition is less than or about 40 micrograms/cm².

3. The fuel cell of claim 2 wherein the loading of the secondary catalyst composition is less than or about 20 micrograms/cm².

4. The fuel cell of claim 1 wherein the anode consists essentially of the primary catalyst composition layer and the secondary catalyst composition layer.

5. The fuel cell of claim 1 wherein the anode gas diffusion layer comprises a microporous layer adjacent the secondary catalyst composition layer.

6. The fuel cell of claim 1 wherein the primary catalyst composition is selected from the group consisting of Pt, Pd, and alloys thereof.

7. The fuel cell of claim 6 wherein the primary catalyst composition is supported on a support selected from the group consisting of carbon, tungsten, perylene, and metal oxides.

8. The fuel cell of claim 1 wherein the secondary catalyst composition is selected from the group consisting of RuIrO₂, other ruthenium-iridium oxides with varied ratios of Ru to Ir, RuO₂, IrO₂, Ru, Ir, and solid solutions thereof.

9. The fuel cell of claim 8 wherein the secondary catalyst composition is RuIrO₂.

10. A solid polymer electrolyte fuel cell comprising a cathode, a solid polymer electrolyte, an anode, a cathode gas diffusion layer, and an anode gas diffusion layer, the anode comprising a primary catalyst composition for hydrogen oxidation and a secondary catalyst composition for oxygen evolution reaction, wherein: the primary catalyst composition is incorporated as a layer located adjacent the solid polymer electrolyte; the secondary catalyst composition is incorporated as a layer located between the primary catalyst composition and the anode gas diffusion layer; and the loading of the secondary catalyst composition is in the range from 1 to 90 micrograms/cm², wherein the secondary catalyst composition layer comprises less than 20 micrograms/cm² of carbon powder additive.

11. The fuel cell of claim 1 wherein the secondary catalyst composition layer comprises perfluorosulfonic acid type polymer additive wherein the ratio of polymer additive to secondary catalyst composition is less than or about 0.1.

12. A method of preparing the fuel cell of claim 1 comprising incorporating the primary catalyst composition on assembly as a layer located adjacent the solid polymer electrolyte; and incorporating the secondary catalyst composition on assembly as a layer located between the primary catalyst composition and the anode gas diffusion layer.

13. A method of preparing the fuel cell of claim 12 comprising:
preparing a solid-liquid dispersion comprising the secondary catalyst composition and a carrier liquid; applying a coating of the dispersion to the primary catalyst composition layer or the anode gas diffusion layer; and removing the carrier liquid.

14. The method of claim 13 comprising applying the coating of the dispersion to the anode gas diffusion layer.

15. A method for improving durability while maintaining reversal tolerance of a solid polymer electrolyte fuel cell, the solid polymer electrolyte fuel cell comprising a cathode, a solid polymer electrolyte, an anode, a cathode gas diffusion layer, and an anode gas diffusion layer, the anode comprising a primary catalyst composition for hydrogen oxidation and a secondary catalyst composition for oxygen evolution reaction, and the method comprising:
incorporating the primary catalyst composition as a layer located adjacent the solid polymer electrolyte; incorporating the secondary catalyst composition as a layer located between the primary catalyst composition and the anode gas diffusion layer wherein the secondary catalyst composition layer is characterized by a loading of the secondary catalyst composition; and reducing the loading of the secondary catalyst composition to a value in the range from 1 to 90 micrograms/cm².

16. The fuel cell of claim 10 wherein the carbon powder additive is carbon black.

17. A solid polymer electrolyte fuel cell comprising a cathode, a solid polymer electrolyte, an anode, a cathode gas diffusion layer, and an anode gas diffusion layer, the anode comprising a primary catalyst composition for hydrogen oxidation and a secondary catalyst composition for oxygen evolution reaction, wherein:
the primary catalyst composition is incorporated as a layer located adjacent the solid polymer electrolyte;
the secondary catalyst composition is RuIrO₂ incorporated as a layer located between the primary catalyst composition and the anode gas diffusion layer; and
the loading of the secondary catalyst composition is 20 micrograms/cm².
